(19) United States
(12) Patent Application Publication
(10) Pub. No.: US 2025/0331043 A1
(43) Pub. Date: Oct. 23, 2025

(54) COMMUNICATION SYSTEM AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 18/740,113

(22) Filed: Jun. 11, 2024

(30) Foreign Application Priority Data
Apr. 17, 2024 (TW) 113114262

(51) Int. Cl. H04W 76/15; H04W 84/18; H04W 88/04

(52) U.S. Cl. CPC H04W 76/15; H04W 84/18; H04W 88/04

(57) ABSTRACT

A communication system includes a first piconet unit and a second piconet unit. The first piconet unit includes a first master element, a first slave element, and a second slave element. A first connection mechanism is established between the first master element and each of the first slave element and the second slave element. The second piconet unit includes a second master element, a third slave element, and a fourth slave element. A second connection mechanism is established between the second master element and each of the third slave element and the fourth slave element. A wireless connection mechanism is established between the first master element and the second master element. The wireless connection mechanism is different from the first connection mechanism and the second connection mechanism.

### CROSS REFERENCE TO RELATED APPLICATIONS

This application claims priority of Taiwan Patent Application No. 113114262 filed on Apr. 17, 2024, the entirety of which is incorporated by reference herein.

### BACKGROUND OF THE INVENTION

### Field of the Invention

The invention relates to a communication system, and more particularly, to a communication system and a communication method.

### Description of the Related Art

In the field of VR (Virtual Reality) and AR (Augmented Reality), one device may be connected to another device in a wired or wireless manner. However, in general, connections tend to have problems of poor communication quality. Accordingly, there is a need to propose a novel solution for solving the problems of the prior art.

### BRIEF SUMMARY OF THE INVENTION

In an exemplary embodiment, the invention is directed to a communication system that includes a first piconet unit and a second piconet unit. The first piconet unit includes a first master element, a first slave element, and a second slave element. A first connection mechanism is established between the first master element and each of the first slave element and the second slave element. The second piconet unit includes a second master element, a third slave element, and a fourth slave element. A second connection mechanism is established between the second master element and each of the third slave element and the fourth slave element. A wireless connection mechanism is established between the first master element and the second master element. The wireless connection mechanism is different from the first connection mechanism and the second connection mechanism.

In some embodiments, each of the first connection mechanism and the second connection mechanism belongs to an HBC (Human Body Communication) connection.

In some embodiments, the wireless connection mechanism belongs to a Bluetooth connection.

In some embodiments, any of the first master element and the second master element is implemented with an HMD (Head Mounted Display).

In some embodiments, any of the first slave element, the second slave element, the third slave element, and the fourth slave element is implemented with a physiological signal sensor, a camera element, or an IMU (Inertial Measurement Unit).

In some embodiments, a third connection mechanism is established between the first slave element and the second slave element. The third connection mechanism is different from the wireless connection mechanism.

In some embodiments, a fourth connection mechanism is established between the third slave element and the fourth slave element. The fourth connection mechanism is different from the wireless connection mechanism.

In some embodiments, each of the third connection mechanism and the fourth connection mechanism belongs to an HBC connection.

In some embodiments, if the second slave element has better communication quality than the first slave element, the second slave element will relay a first data from the first slave element to the first master element.

In some embodiments, if the fourth slave element has better communication quality than the third slave element, the fourth slave element will relay a second data from the third slave element to the second master element.

In another exemplary embodiment, the invention is directed to a communication method that includes the steps of: providing a first piconet unit and a second piconet unit, wherein the first piconet unit includes a first master element, a first slave element and a second slave element, and wherein the second piconet unit includes a second master element, a third slave element and a fourth slave element; establishing a first connection mechanism between the first master element and each of the first slave element and the second slave element; establishing a second connection mechanism between the second master element and each of the third slave element and the fourth slave element; and establishing a wireless connection mechanism between the first master element and the second master element. The wireless connection mechanism is different from the first connection mechanism and the second connection mechanism.

In some embodiments, the communication method further includes: implementing any of the first master element and the second master element with an HMD.

In some embodiments, the communication method further includes: implementing any of the first slave element, the second slave element, the third slave element, and the fourth slave element with a physiological signal sensor, a camera element, or an IMU.

In some embodiments, the communication method further includes: establishing a third connection mechanism between the first slave element and the second slave element. The third connection mechanism is different from the wireless connection mechanism.

In some embodiments, the communication method further includes: establishing a fourth connection mechanism between the third slave element and the fourth slave element. The fourth connection mechanism is different from the wireless connection mechanism.

In some embodiments, the communication method further includes: if the second slave element has better communication quality than the first slave element, relaying a first data from the first slave element to the first master element by the second slave element.

In some embodiments, the communication method further includes: if the fourth slave element has better communication quality than the third slave element, relaying a second data from the third slave element to the second master element by the fourth slave element.

### BRIEF DESCRIPTION OF DRAWINGS

The invention can be more fully understood by reading the subsequent detailed description and examples with references made to the accompanying drawings, wherein:

FIG. 1 is a diagram of a communication system according to an embodiment of the invention;

FIG. 2 is a diagram of a piconet unit according to an embodiment of the invention;

FIG. 3 is a diagram of a communication system according to an embodiment of the invention; and

FIG. 4 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

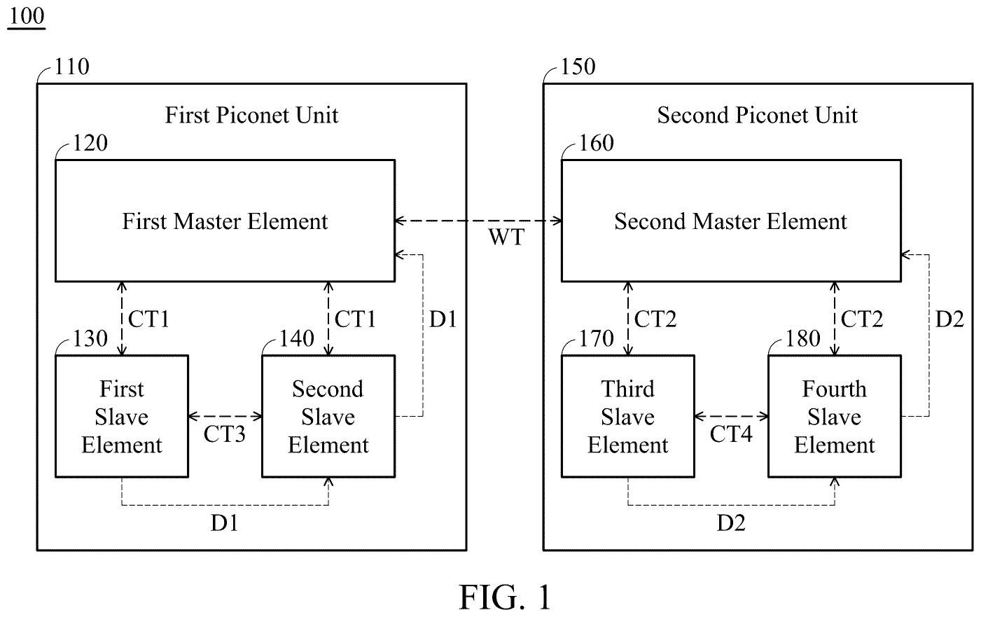

FIG. 1 is a diagram of a communication system 100 according to an embodiment of the invention. For example, the communication system 100 may be applied to relative equipment of VR (Virtual Reality) or AR (Augmented Reality). Alternatively, the communication system 100 may be applied to a plurality of mobile devices, such as smart phones, tablet computers, or notebook computers, but it is not limited thereto. In the embodiment of FIG. 1, the communication system 100 at least includes a first piconet unit 110 and a second piconet unit 120. It should be understood that the communication system 100 may include more piconet units, and each of the piconet units may include other components, such as a battery, a touch control panel, a speaker, a power supply module and/or a housing, although they are not displayed in FIG. 1.

The first piconet unit 110 includes a first master element 120, a first slave element 130, and a second slave element 140. A first connection mechanism CT1 can be established between the first master element 120 and each of the first slave element 130 and the second slave element 140. In some embodiments, the first slave element 130 and the second slave element 140 can be directly or indirectly controlled by the first master element 120. In alternative embodiments, the first piconet unit 110 includes more slave elements.

The second piconet unit 150 includes a second master element 160, a third slave element 170, and a fourth slave element 180. A second connection mechanism CT2 can be established between the second master element 160 and each of the third slave element 170 and the fourth slave element 180. In some embodiments, the third slave element 170 and the fourth slave element 180 can be directly or indirectly controlled by the second master element 160. In alternative embodiments, the second piconet unit 150 includes more slave elements.

In addition, a wireless connection mechanism WT can be established between the first master element 120 and the second master element 160. It should be noted that the wireless connection mechanism WT is different from the first connection mechanism CT1 and the second connection mechanism CT2 as mentioned above. In other words, the second piconet unit 150 can communicate with the first piconet unit 110 in a different way, so as to provide the benefit of a diversity design.

In some embodiments, any of the first master element 120 and the second master element 160 is implemented with an HMD (Head Mounted Display), but it is not limited thereto.

In some embodiments, any of the first slave element 130, the second slave element 140, the third slave element 170, and the fourth slave element 180 is implemented with a physiological signal sensor, a camera element, or an IMU (Inertial Measurement Unit), but it is not limited thereto.

In some embodiments, each of the first connection mechanism CT1 and the second connection mechanism CT2 belongs to an HBC (Human Body Communication) connection. That is, the aforementioned HBC connection is arranged as an internal communication mechanism of each of the first piconet unit 110 and the second piconet unit 150.

In some embodiments, the wireless connection mechanism WT belongs to a Bluetooth connection, such as a BLE (Bluetooth Low Energy) connection. That is, the aforementioned Bluetooth connection is arranged as an external communication mechanism between the first piconet unit 110 and the second piconet unit 150. For example, the aforementioned Bluetooth connection may be applied to the transmission of control signals, and the aforementioned HBC connection may be applied to the transmission of data signals, but they are not limited thereto.

With the proposed design for the invention, the wireless connection mechanism WT is only used between the first master element 120 of the first piconet unit 110 and the second master element 160 of the second piconet unit 150, so as to effectively save limited bandwidth resources. According to practical measurements, even if there are many piconet units disposed adjacent to each other in the communication system 100, the probability of signal package collision between these piconet units can be significantly reduced.

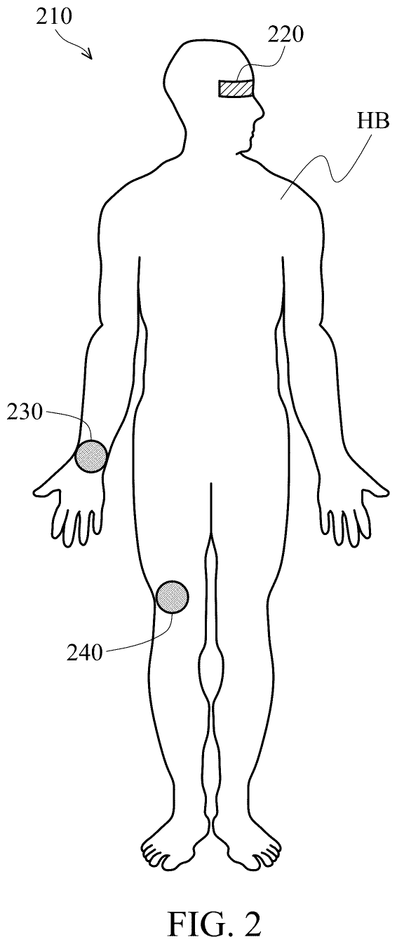

FIG. 2 is a diagram of a piconet unit 210 according to an embodiment of the invention. FIG. 2 is similar to FIG. 1. In the embodiment of FIG. 2, the piconet unit 210 is applied to different portions of a human body HB. The piconet unit 210 includes a master element 220, a slave element 230, and another slave element 240. For example, the master element 220 may be an HMD, the slave element 230 may be a hand sensor for collecting the pulse information of the human body HB, and the slave element 240 may be a leg sensor for collecting the movement information of the human body HB, but they are not limited thereto. The slave element 230 can transmit the pulse information to the master element 220 through the HBC connection. The slave element 240 can also transmit the movement information to the master element 220 through the HBC connection. Then, the master element 220 can selectively share the aforementioned information with another piconet unit (not shown) through the Bluetooth connection. Other features of the piconet unit 210 of FIG. 2 are similar to those of the communication system 100 of FIG. 1. Thus, the two embodiments can achieve similar levels of performance.

Please refer to FIG. 1 again. In some embodiments, a third connection mechanism CT3 can be established between the first slave element 130 and the second slave element 140. The third connection mechanism CT3 is different from the wireless connection mechanism WT. For example, the third connection mechanism CT3 may also belong to an HBC connection. With respect to the first master element 120, the communication quality of the first slave element 130 can be compared with that of the second slave element 140. As shown in FIG. 1, if the second slave element 140 has better communication quality than the first slave element 130 (e.g., corresponding to higher RSSI (Received Signal Strength Indication)), the second slave element 140 can relay a first data D1 from the first slave element 130 to the first master element 120. Conversely, if the first slave element 130 has better communication quality than the second slave element 140, the first slave element 130 can relay the first data DI from the second slave element 140 to the first master element 120 (not shown). That is, the first piconet unit 110 can perform a first payload trunk process to select an appropriate slave element for data transmission, thereby increasing the transmission efficiency of the first data D1.

In alternative embodiments, a fourth connection mechanism CT4 can be established between the third slave element 170 and the fourth slave element 180. The fourth connection mechanism CT4 is different from the wireless connection mechanism WT. For example, the fourth connection mechanism CT4 may also belong to an HBC connection. With respect to the second master element 160, the communication quality of the third slave element 170 can be compared with that of the fourth slave element 180. As shown in FIG. 1, if the fourth slave element 180 has better communication quality than the third slave element 170 (e.g., corresponding to higher RSSI), the fourth slave element 180 can relay a second data D2 from the third slave element 170 to the second master element 160. Conversely, if the third slave element 170 has better communication quality than the fourth slave element 180, the third slave element 170 can relay the second data D2 from the fourth slave element 180 to the second master element 160 (not shown). That is, the second piconet unit 150 can perform a second payload trunk process to select an appropriate slave element for data transmission, thereby increasing the transmission efficiency of the second data D2.

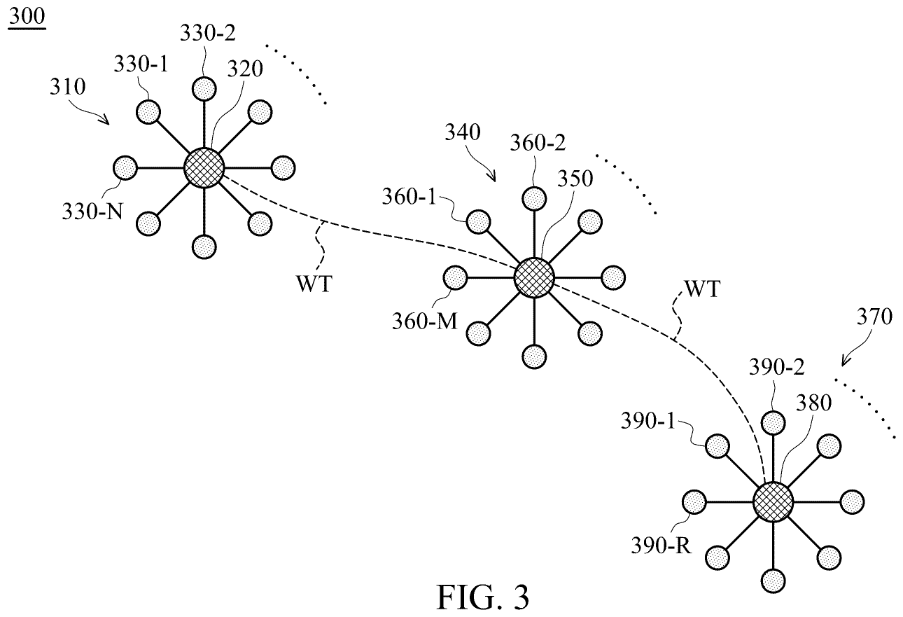

FIG. 3 is a diagram of a communication system 300 according to an embodiment of the invention. FIG. 3 is similar to FIG. 1. In the embodiment of FIG. 3, the communication system 300 includes three piconet units 310, 340 and 370 which are adjacent to each other. Specifically, the piconet unit 310 includes a master element 320 and a plurality of slave elements 330-1, 330-2, . . . , and 330-N, the piconet unit 340 includes a master element 350 and a plurality of slave elements 360-1, 360-2, . . . , and 360-M, and the piconet unit 370 includes a master element 380 and a plurality of slave elements 390-1, 390-2, . . . , and 390-R, where each of “N”, “M” and “R” may be a positive integer greater than or equal to 3. In the communication system 300, only a wireless connection mechanism WT can be established between the master elements 320, 350 and 380. Since the wireless connection mechanism WT is not occupied by the other slave elements 330-1, 330-2, . . . , and 330-N, 360-1, 360-2, . . . , and 360-M, and 390-1, 390-2, . . . , and 390-R, the communication system 300 can easily maintain its high communication quality. Other features of the communication system 300 of FIG. 3 are similar to those of the communication system 100 of FIG. 1. Thus, the two embodiments can achieve similar levels of performance. It should be noted that the term “adjacent” or “close” over the disclosure means that the distance (spacing) between two corresponding elements is smaller than a predetermined distance (e.g., 20 m or the shorter), but often does not mean that the two corresponding elements directly touch each other (i.e., the aforementioned distance/spacing between them is reduced to 0).

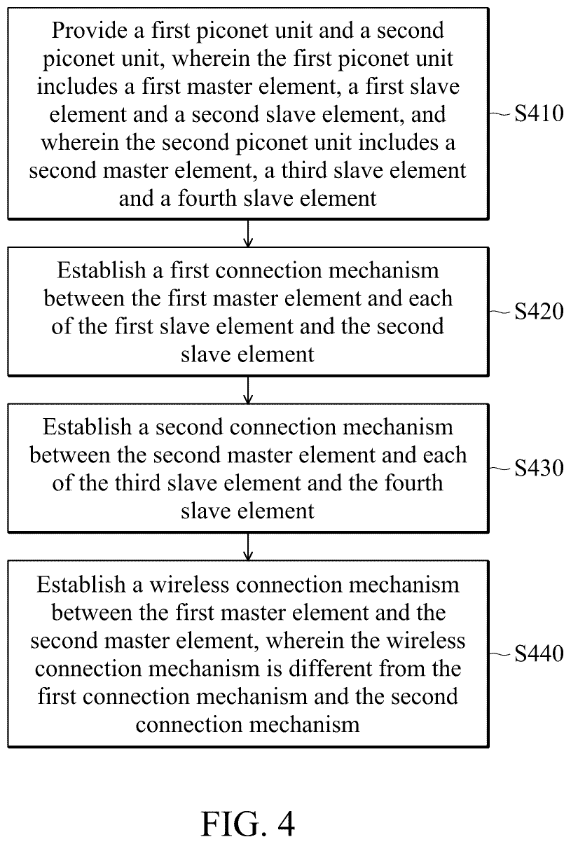

FIG. 4 is a flowchart of a communication method according to an embodiment of the invention. To begin, in step S410, a first piconet unit and a second piconet unit are provided. The first piconet unit includes a first master element, a first slave element and a second slave element. The second piconet unit includes a second master element, a third slave element and a fourth slave element. In step S420, a first connection mechanism is established between the first master element and each of the first slave element and the second slave element. In step S430, a second connection mechanism is established between the second master element and each of the third slave element and the fourth slave element. Finally, in step S440, a wireless connection mechanism is established between the first master element and the second master element. The wireless connection mechanism is different from the first connection mechanism and the second connection mechanism. It should be understood that these steps are not required to be performed in order, and every feature of the embodiments of FIGS. 1-3 may be applied to the communication method of FIG. 4.

The invention proposes a novel communication system and a novel communication method. In comparison to the conventional design, the invention has at least the advantages of improving the overall communication quality, saving the bandwidth resources, and reducing the probability of signal package collision. Therefore, the invention is suitable for application in a variety of devices.

Note that the above element parameters are not limitations of the invention. A designer can fine-tune these setting values according to different requirements. It should be understood that the communication system and the communication method of the invention are not limited to the configurations of FIGS. 1-4. The invention may include any one or more features of any one or more embodiments of FIGS. 1-4. In other words, not all of the features displayed in the figures should be implemented in the communication system and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication system, comprising:
a first piconet unit, comprising:
a first master element;
a first slave element; and
a second slave element, wherein a first connection mechanism is established between the first master element and each of the first slave element and the second slave element; and
a second piconet unit, comprising:
a second master element;
a third slave element; and
a fourth slave element, wherein a second connection mechanism is established between the second master element and each of the third slave element and the fourth slave element;
wherein a wireless connection mechanism is established between the first master element and the second master element;
wherein the wireless connection mechanism is different from the first connection mechanism and the second connection mechanism.

2. The communication system as claimed in claim 1, wherein each of the first connection mechanism and the second connection mechanism belongs to an HBC (Human Body Communication) connection.

3. The communication system as claimed in claim 1, wherein the wireless connection mechanism belongs to a Bluetooth connection.

4. The communication system as claimed in claim 1, wherein any of the first master element and the second master element is implemented with an HMD (Head Mounted Display).

5. The communication system as claimed in claim 1, wherein any of the first slave element, the second slave element, the third slave element, and the fourth slave element is implemented with a physiological signal sensor, a camera element, or an IMU (Inertial Measurement Unit).

6. The communication system as claimed in claim 1, wherein a third connection mechanism is established between the first slave element and the second slave element, and the third connection mechanism is different from the wireless connection mechanism.

7. The communication system as claimed in claim 6, wherein a fourth connection mechanism is established between the third slave element and the fourth slave element, and the fourth connection mechanism is different from the wireless connection mechanism.

8. The communication system as claimed in claim 7, wherein each of the third connection mechanism and the fourth connection mechanism belongs to an HBC connection.

9. The communication system as claimed in claim 6, wherein if the second slave element has better communication quality than the first slave element, the second slave element relays a first data from the first slave element to the first master element.

10. The communication system as claimed in claim 7, wherein if the fourth slave element has better communication quality than the third slave element, the fourth slave element relays a second data from the third slave element to the second master element.

11. A communication method, comprising the steps of:
providing a first piconet unit and a second piconet unit, wherein the first piconet unit comprises a first master element, a first slave element and a second slave element, and wherein the second piconet unit comprises a second master element, a third slave element and a fourth slave element;
establishing a first connection mechanism between the first master element and each of the first slave element and the second slave element;
establishing a second connection mechanism between the second master element and each of the third slave element and the fourth slave element; and
establishing a wireless connection mechanism between the first master element and the second master element;
wherein the wireless connection mechanism is different from the first connection mechanism and the second connection mechanism.

12. The communication method as claimed in claim 11, wherein each of the first connection mechanism and the second connection mechanism belongs to an HBC connection.

13. The communication method as claimed in claim 11, wherein the wireless connection mechanism belongs to a Bluetooth connection.

14. The communication method as claimed in claim 11, further comprising:
implementing any of the first master element and the second master element with an HMD.

15. The communication method as claimed in claim 11, further comprising:
implementing any of the first slave element, the second slave element, the third slave element, and the fourth slave element with a physiological signal sensor, a camera element, or an IMU.

16. The communication method as claimed in claim 11, further comprising:
establishing a third connection mechanism between the first slave element and the second slave element, wherein the third connection mechanism is different from the wireless connection mechanism.

17. The communication method as claimed in claim 16, further comprising:
establishing a fourth connection mechanism between the third slave element and the fourth slave element, wherein the fourth connection mechanism is different from the wireless connection mechanism.

18. The communication method as claimed in claim 17, wherein each of the third connection mechanism and the fourth connection mechanism belongs to an HBC connection.

19. The communication method as claimed in claim 16, further comprising:
if the second slave element has better communication quality than the first slave element, relaying a first data from the first slave element to the first master element by the second slave element.

20. The communication method as claimed in claim 17, further comprising:
if the fourth slave element has better communication quality than the third slave element, relaying a second data from the third slave element to the second master element by the fourth slave element.
